(19) United States
(12) Patent Application Publication
(10) Pub. No.: US 2025/0289154 A1
(43) Pub. Date: Sep. 18, 2025

(54) MULTI-BLADE GROOMING APPLIANCE WITH CUSTOMIZABLE BLADE CONFIGURATIONS PLACED IN METAL CARTRIDGES

(71) Applicant: Seth Koster, Las Cruces, NM (US)

(72) Inventor: Seth Koster, Las Cruces, NM (US)

(21) Appl. No.: 18/608,346

(22) Filed: Mar. 18, 2024

(51) Int. Cl. B26B 21/22; B26B 21/52

(52) U.S. Cl. CPC B26B 21/22; B26B 21/521; B26B 21/522

(57) ABSTRACT

The invention is for a razor that is made from a solid piece of material, including a handle and razor head. The razor head would be able to accept multiple loose blades separated by a spacer, preferably biodegradable. The loose blades could also distributed in a recyclable housing that clips into the razor head, wherein the blades were able to be removed from the housing. In the case of the loose blades, the blades would be attached to the head using a threaded fastener such as a screw or bolt. The entire razor would be easily disposed of in the owner's recycling bins so as to not make the normal waste of throwing the blades and the plastic housing, which prevents them from being recycled.

### BACKGROUND

Gillette™ created the first safe razor that allowed for easily disposed of cartridges made of metal blades placed in a plastic cartridge in 1975. This innovation allowed for men and women to buy a razor with a replaceable cartridge that could be thrown away once the blades started to dull. Dull blades result in poor shaving results as well as a danger to the user, as they may press harder to remove the hairs. The issue with this design is that it creates a large amount of plastic waste as each cartridge only has a certain amount of uses before the blades in the cartridge begin to dull and the user throws it in the trash. While there have been improvements in the number of blades and other features that result in a better shave, there has not been a solution to the amount of trash created by these disposable cartridges.

### SUMMARY OF THE INVENTION

The current invention introduces an entirely metal razor from the handle, the cartridge, and the blades. This design allows for each portion of the razor to be recycled along with other metal that the user recycles, which cuts down dramatically on the amount of waste created by the user. This allows the user to feel comfortable using disposable razor blades with sacrificing the ease and functionality of a traditional disposable razors.

In a preferred embodiment, the number of blades would be customizable from a single blade to up to four blades, giving the user a customized shaving experience that is not capable with traditional disposable blade razors. When the user feels that the blades are no longer providing the best shaving experience, the user simply removes the blades and disregards them in their recycling bin. In one embodiment, the user could send the blades directly back to the manufacturer to be recycled directly by the maker of the razor.

### BRIEF DESCRIPTIONS OF DRAWINGS

FIG. 1 shows the underside of the razor body.

FIG. 2 shows the topside of the razor body.

FIG. 3 shows the side view of the razor body.

FIG. 4 shows the top of spacer.

FIG. 5 shows the side of the spacer.

FIG. 6 shows the top side of a razor blade.

FIG. 7 shows an angled top view of the razor blade.

FIG. 8 shows a back side view of the razor blade.

FIG. 9 shows a side profile view of the razor blade.

FIG. 10 shows a transparent view of the topside of the razor body.

FIG. 11 shows a transparent view of the side view of the razor body.

FIG. 12 shows a transparent view of the underside of the razor body.

FIG. 13 shows a transparent view of a second embodiment of the underside of the razor body.

FIG. 14 shows a solid view of a second embodiment of the underside of the razor body.

FIG. 15 shows a transparent view of a second embodiment of the side of the razor body.

FIG. 16 shows a solid view of a second embodiment of the side of the razor body.

FIG. 17 shows a transparent view of a second embodiment of the angled view of the razor body.

FIG. 18 shows a solid view of a second embodiment of the angled view of the razor body.

FIG. 19 shows a transparent view of a second embodiment of the razor head.

FIG. 20 shows a solid view of a second embodiment of the razor head.

FIG. 21 shows a transparent view of a second embodiment of the razor blade securing portion.

FIG. 22 shows a solid view of a second embodiment of the razor blade securing portion.

### DETAILED DESCRIPTION

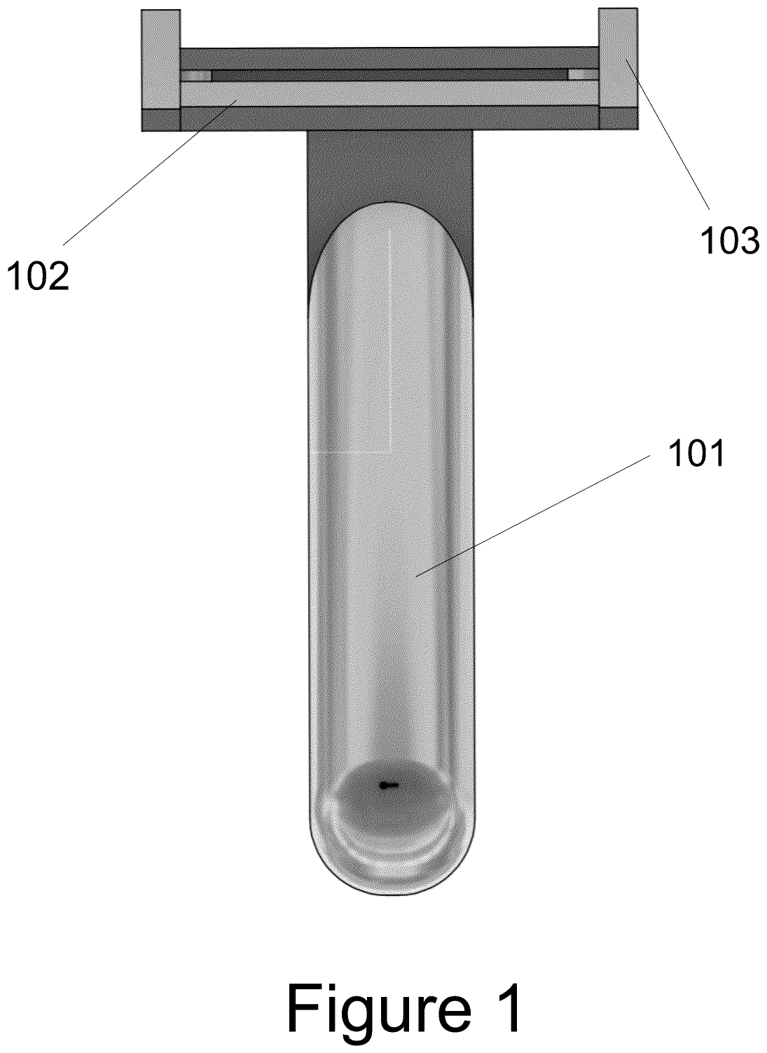

FIG. 1 shows the underside of the razor handle and head. The handle and head would be made out of a single piece of metal, ideally stainless steel, but other metals such as brass could be used to create a vintage look or zamak could be used for mass producing a model cheaper than the stainless steel or the brass. A recyclable plastic could also be used in place of the metal to lower the weight and cost of the razor. The handle 101 would be a uniform cylinder that tapers at the bottom but connects up to the head 102 of the razor, where the blades are inserted. The razor head 102 would have protrusions on either side 103 that hold the blades in place in the horizontal direction.

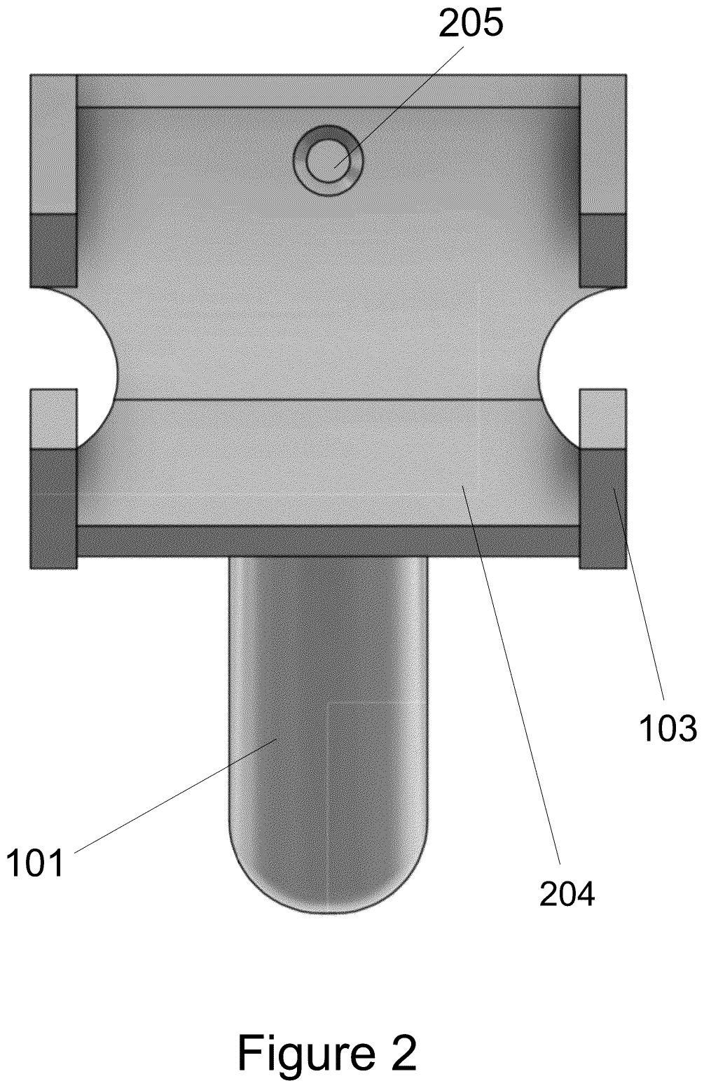

FIG. 2 shows a top view of the razor handle and body. Double edged razor blades are inserted onto the head so that they lie flat on the head 204. If the user only requires a single blade for their shaving experience, the user would attach the razor head fastener that screws onto the head using a screw that attaches to the threaded hole 205 via a bolt with a textured head that allows for hand tightening. The screw could also contain a slotted or Phillips head top to allow for a more secure attachment. If the user wanted more than a single blade, then additional blades could be placed on top of the single blade. To create a separation between the additional blades, a spacer is placed between each of the blades before attaching the head fastener. The spacers would ideally be made of a metal to allow for them to be thrown away without the user having to worry about creating excess garbage as the spacers would be recyclable like the blades. Any combination of blade numbers could be used from a single blade up to four blades stacked on top of each other. The divide shown in the head 204, would create a gap between the razor blade and the head by angling down and away from the blade. Ideally the angle that the blades achieve when attached to the head would be 48 degrees, but any angle in a range from 40 to 55 degrees would also work.

In another embodiment, the blades would be provided to the user within a cartridge that contains the preferred number of blades, which would prevent the user from having to handle the individual razor blades for increased safety for the user. The blades would be encased in a paper based material that would dissolve when they made contact with a liquid, such as water. The blades would be separated by spacers that are made of a biodegradable material that can withstand being in contact with a liquid. The biodegradable material would ideally be a wood pump or other organic material that would break down quickly after the user recycles the cartridge. The cartridge could optionally include a snap in feature along with the screw to enable quick switching of cartridges.

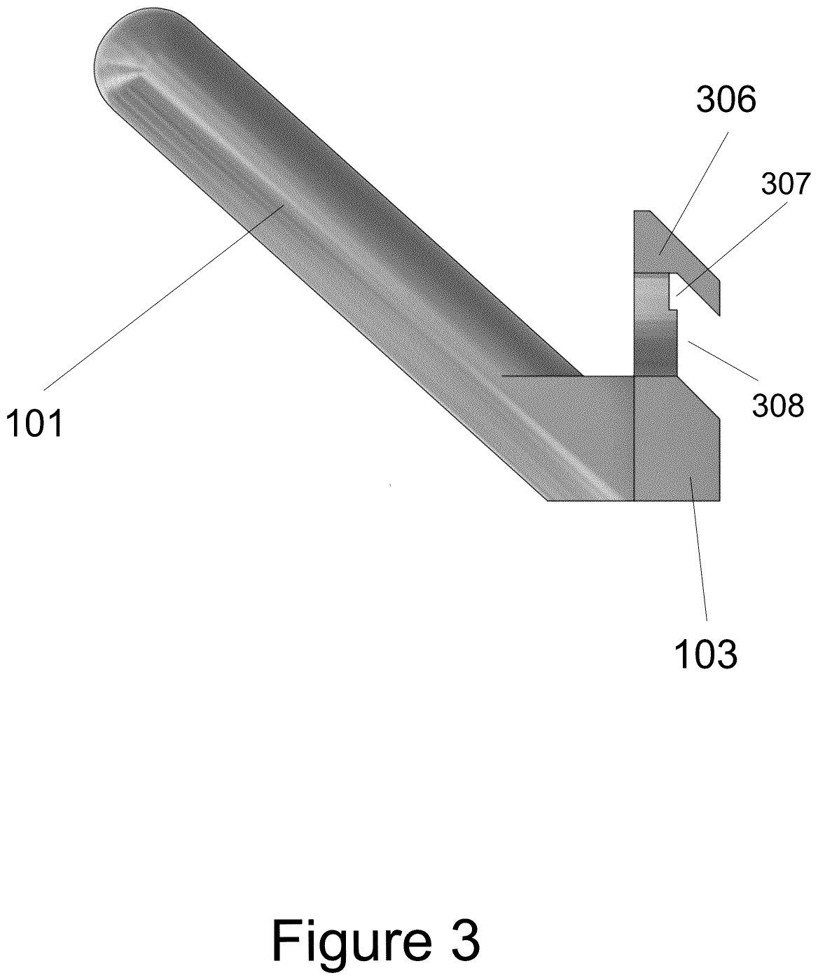

FIG. 3 shows a side view of the razor handle 101 and head 102. The angle of where the handle meets the head would be greater 45 degrees, but could be any angle which give the user the most control during a shave. The angle where the blades meet the user's skin would ideally be a 45 degree angle, but could be any angle that would allow for the best shave for the user. The 45 degree angle between the blades and the user's skin would reduce the pulling of hair during a shave. The first blade, or only blade when used as a single blade razor, would rest against head portion 308. The gap between the head and portion 307 allows for a small gap to exist between the head and the blade itself to enable clearance for the blade to make contact with the shaving surface and create a place for the hair to collect with each stroke of the razor.

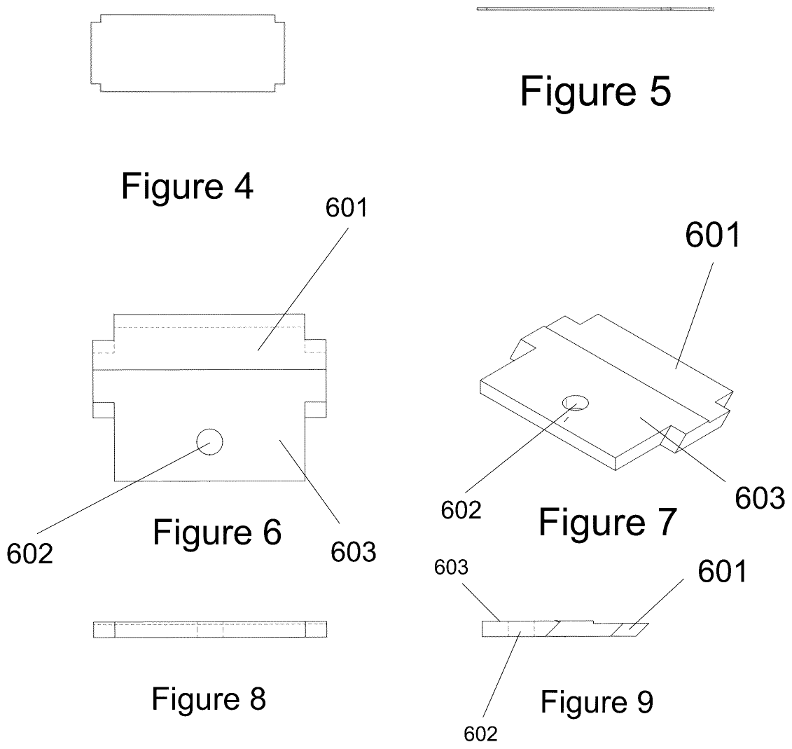

FIG. 4 and FIG. 5 show the biodegradable or metal spacers used to keep the blades apart during shaving. They are a rectangular shape with notches in each corner to keep the spacers in place during shaving. The spacers have a uniform depth to ensure that the blades sit flatly against them on either side.

FIG. 6, FIG. 7, FIG. 8, and FIG. 9 show the razor blade used in the cartridges, either installed by the user or pre-installed in the cartridges. The blades have a similar shape to the spacers, but extend in the horizontal and vertical directions (according to FIGS. 4 and 6) to maintain the space between the blades without interfering with the contact the blade's make with the user's skin. Portion 601 is smaller in depth than portion 603 so as to allow for an additional space between the blades to allow for the hair being shaved to not block the edge of the blades. The side extrusions are used to keep the blades in place in the razor head or cartridge by sliding them into the razor head. 602 is the hole, for the versions that have holes, for allowing the blades to be screwed into the razor head.

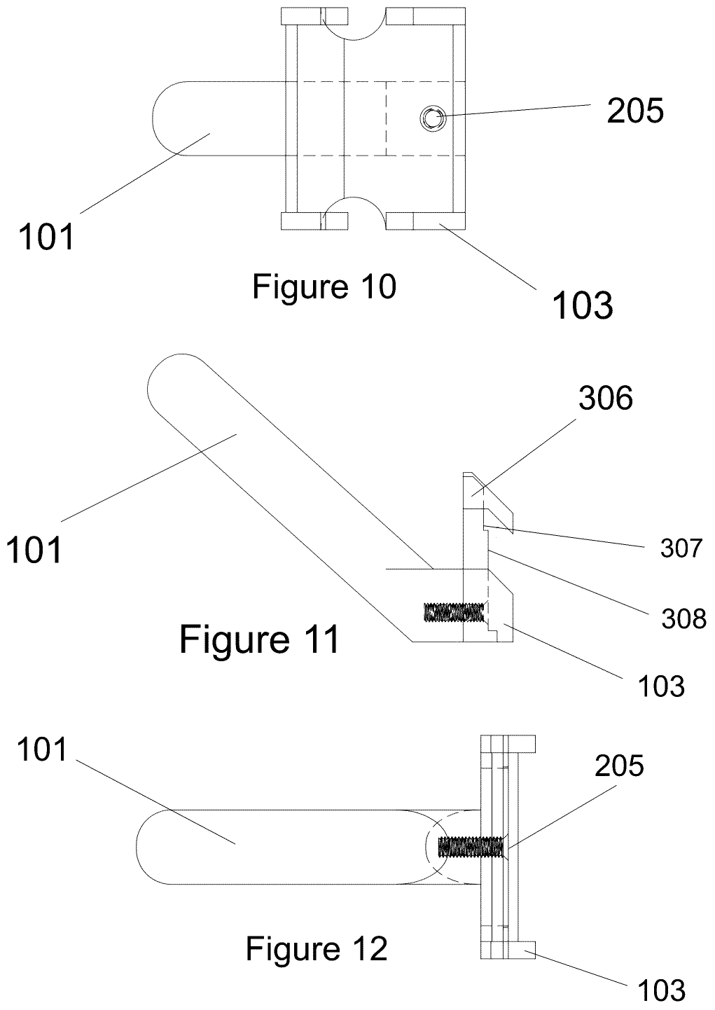

FIG. 10, FIG. 11, and FIG. 12 show the razor blade as shown in FIGS. 1-3, but in a slightly transparent view. Specifically, the figures show the details of the internal threaded portion 205 that allows for the cartridge to be attached to the razor body. The internal threads would preferably be drilled and threaded directly into the metal razor body as shown. But in an alternative embodiment where the razor body is made of a material that cannot be drilled and threaded, then a metal insert would be embedded into the razor body, the insert containing the threads that allow for the fastening screw or bolt for attaching the razor blades or razor blade cartridge.

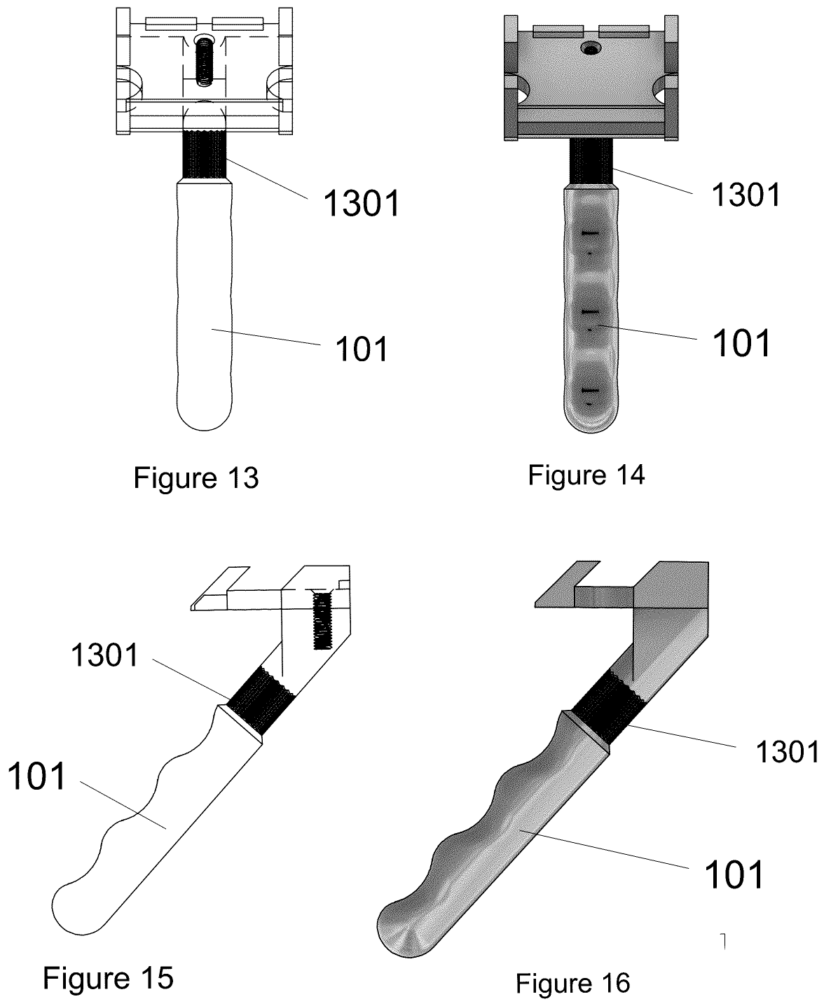

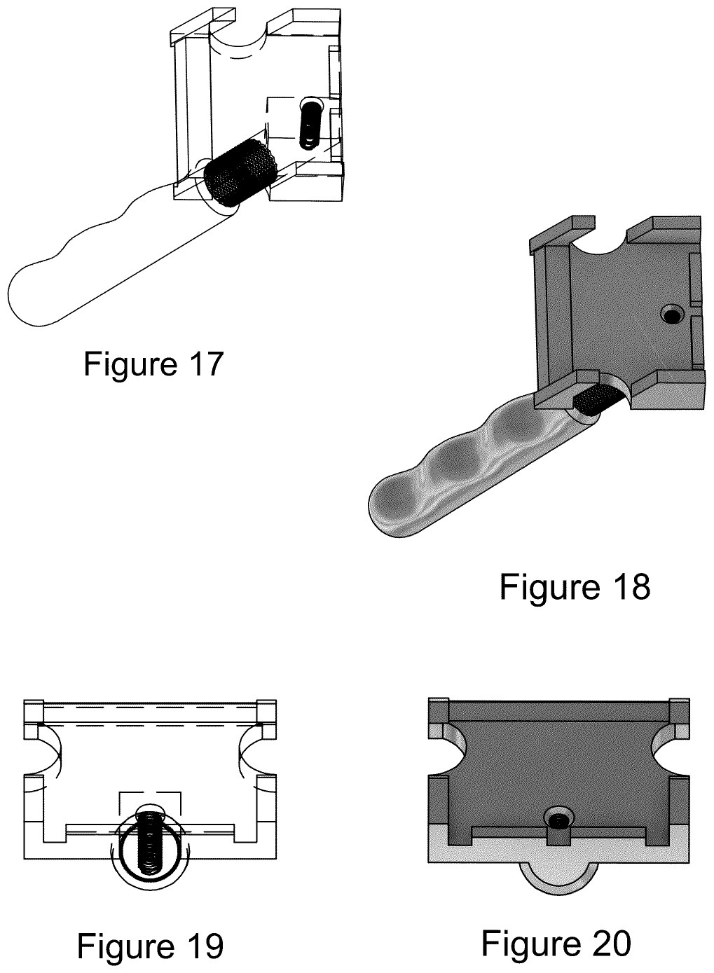

FIG. 13, FIG. 14, FIG. 15, and FIG. 16 show a second embodiment of the razor blade handle and head. The fundamental nature of the first embodiment and second embodiment are the same, except for the shape of the razor handle. The handle in the second embodiment are crafted from a single piece or material that includes the razor head. The difference between the handles is that the handle in the second embodiment has a textured handle 101. This texture handle is ideally created by placing finger sized divots on the underside of the razor handle. The divots could also go around the entire handle of the razor handle and be of any length and/or depth. The portion of the handle that connects the base of the handle 101 to the razor head 1301 could be scored either vertically or horizontally around the portion of the razor handle. The portion 1301 could be any length or diameter. The purpose of the divots would be to provide a flair to the razor design to differentiate it from other similar products, it could be functional providing the user with a better grip on the handle, or it could be a combination.

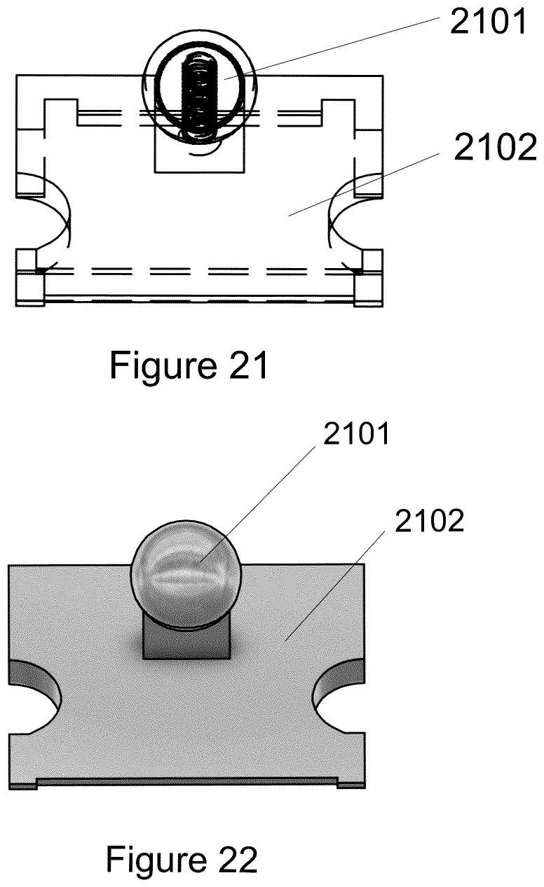

FIG. 21 and FIG. 22 show the separate part of the razor that holds the blades in their position to prevent them from shifting during use, which could cause uneven shaves or harm to the user. Part 2102 is the base of the blade securing portion of the razor, which is the same size and shape as the top view of the razor head shown in FIG. 2 part 204 without the protruding edges 103. The blade securing portion in this embodiment has a connected hand screw 2101 for attaching the portion to the razor head. The exposed part of the screw is ideally a sphere, but it could be a cylinder, square, rectangle, triangle, or any other shape and/or size.

We claim:

1. A shaving system, comprising:
a razor comprising a handle and head, the razor being made of a single uniform material;
the razor handle is of a cylindrical or cuboid shape that is uniform in width, wherein the razor head is positioned at an angle on one end of the handle;
the head comprising a flat rectangular portion positioned at the angle at the end of the handle, wherein:
the smaller sides of the rectangular portion having rectangular border portions protruding from the rectangular portion; wherein
the border portions are divided in the middle, which provides a gap for one or more razor blades to be placed flat on the rectangular portion;
the razor head and handle containing a threaded insert for placing a second rectangular portion that is placed on top of the one or more blades; wherein
wherein the second rectangular portion has an unthreaded hole, which allows for a threaded connector to be inserted through the second rectangular portion and into the threaded hole in the razor to attach the second rectangular portion to the razor.

2. The shaving system of claim 1, wherein:
the razor head is able to incorporate one to four razor blades at a single time.

3. The shaving system of claim 2, wherein:
the blades are separated by a spacer.

4. The shaving system of claim 3, wherein:
the spacer is biodegradable.

5. The shaving system of claim 3, wherein:
the razor blades are secured via a fastener that screws into the threaded hole.

6. The shaving system of claim 4, wherein:
the fastener top is slotted.

7. The shaving system of claim 4, wherein:
the fastener top is a solid smooth object.

8. The shaving system of claim 3, wherein:
the razor blades are attached to the head with a pressure clip.

9. The shaving system of claim 1, wherein:
a blade attachment with the blades already attached can be used instead of the individual blades, wherein the blades are separated by biodegradable spacers.

10. The shaving system of claim 1, wherein:
the angle between the handle and the head is between 40 and 55 degrees.

11. The shaving system of claim 10, wherein:
the angle between the handle and the head is 48 degrees.

12. The shaving system of claim 10, wherein:
the angle between the handle and the head is 45 degrees.

13. The shaving system of claim 1, wherein:
the razor is manufactured from metal.

14. The shaving system of claim 13, wherein:
the metal used in manufacturing is steel.

15. The shaving system of claim 13, wherein:
the metal used in manufacturing is brass.

16. The shaving system of claim 13, wherein:
the metal used in manufacturing is stainless steel.

17. The shaving system of claim 1, wherein:
the handle is has finger sized divots on a single side.

18. The shaving system of claim 1, wherein:
the razor is molded from plastic.

19. The shaving system of claim 1, wherein:
the razor is molded from injected plastic.
